(19) United States
(12) Patent Application Publication
(10) Pub. No.: US 2009/0128630 A1
(43) Pub. Date: May 21, 2009

(54) VEHICLE IMAGE DISPLAY SYSTEM AND IMAGE DISPLAY METHOD

(75) Inventors: Akihiro KANAOKA, Hadano-shi (JP); Makoto KIMURA, Sagamihara-shi (JP); Kazuhiko SAKAI, Guangzhou (CN); Daisuke SUGAWARA, Isehara-shi (JP)

Correspondence Address: FOLEY AND LARDNER LLP;SUITE 500, 3000 K STREET NW, WASHINGTON, DC, 20007, US

(73) Assignee: NISSAN MOTOR CO., LTD.

(21) Appl. No.: 12/354,201

(22) Filed: Jan. 15, 2009

Related U.S. Application Data
(63) Continuation-in-part of application No. 11/822,352, filed on Jul. 5, 2007.

(30) Foreign Application Priority Data
Jul. 6, 2006 (JP) 2006-186719
Jun. 15, 2007 (JP) 2007-158647

(51) Int. Cl. H04N 7/18; G06K 9/36

(52) U.S. Cl. 348/148; 382/284; 348/E07.085

(57) ABSTRACT

When an image processing device subjects images photographed by on-vehicle cameras to viewpoint changing, and joints the images to form a top view image, and superposes boundary indicators at joints of the top view image to display it as an image with boundary regions to be monitored in a display, the boundary regions, or at least partial areas thereof, of the top view image are changed in appearance until a passage of predetermined time after predetermined conditions are established. Thus, the boundary regions can be made conspicuous only when necessary to be presented to an occupant of a vehicle, and an easily seen top view image can be displayed while preventing a reduction in effectiveness of warning of the boundary regions.

This application is a Continuation-In-Part of U.S. application Ser. No. 11/822,352, which was filed on Jul. 5, 2007, and is hereby incorporated by reference in its entirety.

### BACKGROUND OF THE INVENTION

The present invention relates to an vehicle image display system and an image display method for joining a plurality of images photographed by a plurality of on-vehicle cameras to form a composite image, and then to display the composite image in a display device in a car room.

A technology has conventionally been in widespread use, which joins a plurality of images photographed by a plurality of on-vehicle cameras to form a composite image, and displays the composite image in a display device in a car room to assist driver's field of vision, thereby enhancing safety of vehicle driving. In many cases, the composite image formed by joining the plurality of images does not accurately reflect an actual landscape because of a loss of continuity of images at the joints. Under these circumstances, as disclosed in Japanese Patent Application Laid-Open No. 2003-67735, inaccuracy of images at the joints is indicated by masking the joints of the images, thereby giving a warning to occupants of the vehicle.

### SUMMARY OF THE INVENTION

According to the conventional technology, however, masks have always been superposed on the joints of the composite image in a certain display form. Thus, for example, when the occupants of the vehicle get used to this display, the masks lose visibility, creating a possibility of a reduction in effectiveness of warning.

The present invention has been developed to solve the aforementioned problem of the conventional technology, and it is an object of the invention to provide a vehicle image display system and an image display method which can display a composite image with boundary regions to be easily seen while preventing a reduction in effectiveness of providing a warning with at least one boundary region.

According to the present invention, the vehicle image display system and the image display method solves the problem by changing the appearance of at least a partial area of at least one boundary region of a composite image until a passage of predetermined time after predetermined conditions are established when a plurality of images photographed by a plurality of on-vehicle cameras are jointed to form a composite image, and boundary region are superposed on the composite image to cover joints of the plurality of images, and displayed.

### BRIEF DESCRIPTION OF THE DRAWINGS

FIG. 1 is a block diagram showing a configuration of a vehicle image display system according to the present invention.

FIG. 2 is a diagram showing a specific example of installing positions and photographing areas of four on-vehicle cameras.

FIG. 3 is a diagram showing a top view image formed by changing viewpoints and joining images photographed by the four on-vehicle cameras installed around a vehicle.

FIGS. 4A to 4C are diagrams showing a viewpoint changing process executed by an image synthesis unit of an image processing device: FIG. 4A showing a relation of positions and photographing areas between a real camera and a virtual camera, FIG. 4B showing an image of a photographing area photographed by the real camera (image before viewpoint changing), and FIG. 4C showing an image of a photographing area photographed by the virtual camera (image after viewpoint changing).

FIG. 5 is a diagram showing a situation in which boundary indicators are superposed to cover image joints of the top view image.

FIG. 6 is a diagram showing an example of a screen configuration of an image displayed in a display.

FIG. 7 is a flowchart showing a specific example of a process regarding boundary region display control executed by the image processing device after an ignition switch of the vehicle is turned ON in the vehicle image display system of the embodiment.

FIG. 8 is a diagram showing an exemplary situation in which a partial area of boundary indicators are changed in appearance.

FIG. 9 is a diagram showing another exemplary situation in which a partial area of boundary indicators are changed in appearance.

### DETAILED DESCRIPTION OF THE PREFERRED EMBODIMENTS

A specific example of a vehicle image display system capable of displaying a composite image looking down at all the surroundings of a vehicle from a virtual viewpoint above the vehicle according to an embodiment of the present invention will be described below. The vehicle image display system of the invention includes a function of photographing images of four directions around the vehicle by four on-vehicle cameras of the vehicle, and displaying a plurality of images as images to be monitored in a display of a car room while switching the images according to an operation of a vehicle occupant. The vehicle image display system includes a function of changing viewpoints of original images photographed by the on-vehicle cameras into overview images and joining the images to form a composite image looking down at all the surroundings of the vehicle from a virtual viewpoint above the vehicle, and combining the composite image with one of the original images photographed by the on-vehicle cameras and before viewpoint changing to be displayed as an image to be monitored in the display of the car room.

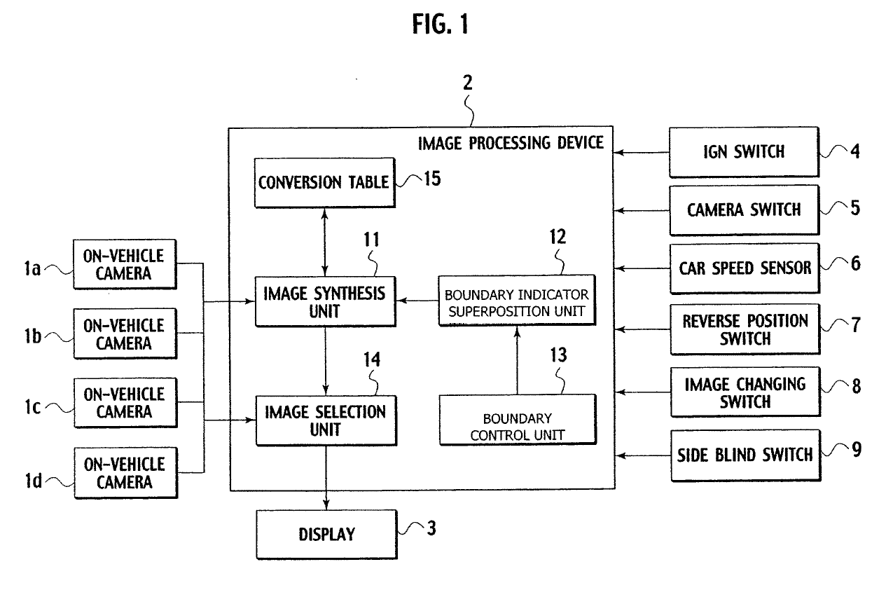

FIG. 1 shows a configuration of the vehicle image display system of the invention. This vehicle image display system includes four on-vehicle cameras 1a to 1d, an image processing device 2, and a display 3 in a car room as main components. An ignition switch 4, a camera switch 5, a car speed sensor 6, a reverse position switch 7, an image changing switch 8, and a side blind switch 9 are connected to the image processing device 2.

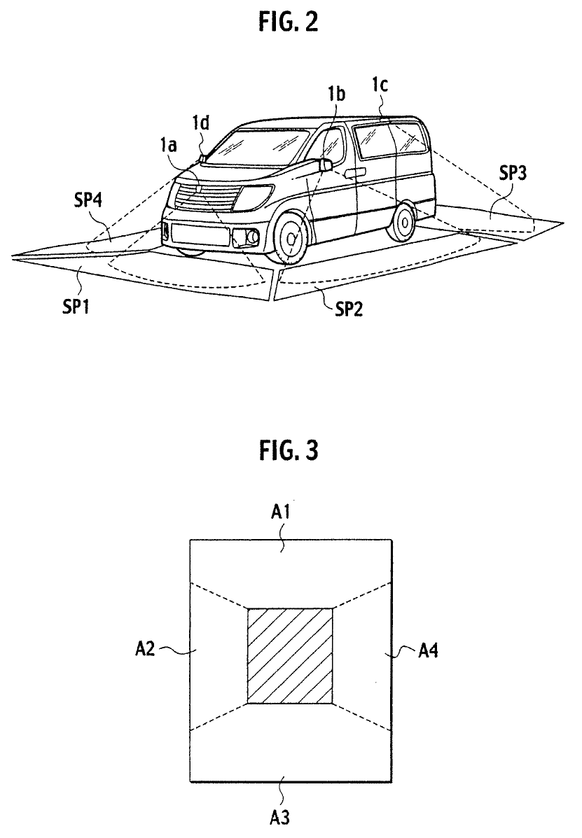

The on-vehicle cameras 1a to 1d are installed in the front, rear, left and right sides of the vehicle to photograph images of four directions around the vehicle. For example, as shown in FIG. 2, the on-vehicle camera 1a is installed in a predetermined position of the front side of the vehicle such as a position near a front grille to photograph an image (front view image hereinafter) of a predetermined photographing area SP1 of the front side of the vehicle. The on-vehicle camera 1b is installed in a predetermined position of the left side of the vehicle such as a left side mirror to photograph an image (left side view image) of a predetermined photographing area SP2 of the left side of the vehicle. The on-vehicle camera 1c is installed in a predetermined area of the rear side of the vehicle such as a roof spoiler to photograph an image (rear view image) of a predetermined photographing area SP3 of the rear side of the vehicle. The on-vehicle camera 1d is installed in a predetermined position of the right side of the vehicle such as a right side mirror to photograph an image (right side view image) of a predetermined photographing area SP4 of the right side of the vehicle. Data of the images photographed by the four on-vehicle cameras 1a to 1d are fed to the image processing device 2 as needed.

The image processing device 2 includes an image synthesis unit 11 for forming a composite image having boundary regions (top view image hereinafter) looking down at all the surroundings of the vehicle from a virtual viewpoint above the vehicle, a boundary indicator superposition unit 12 for superposing boundary indicators on the top view image formed by the image synthesis unit 11, a boundary control unit 13 for controlling a display form of at least a partial area of at least one boundary region, and an image selection unit 14 for selecting an image to be displayed as an image to be monitored in the display 3.

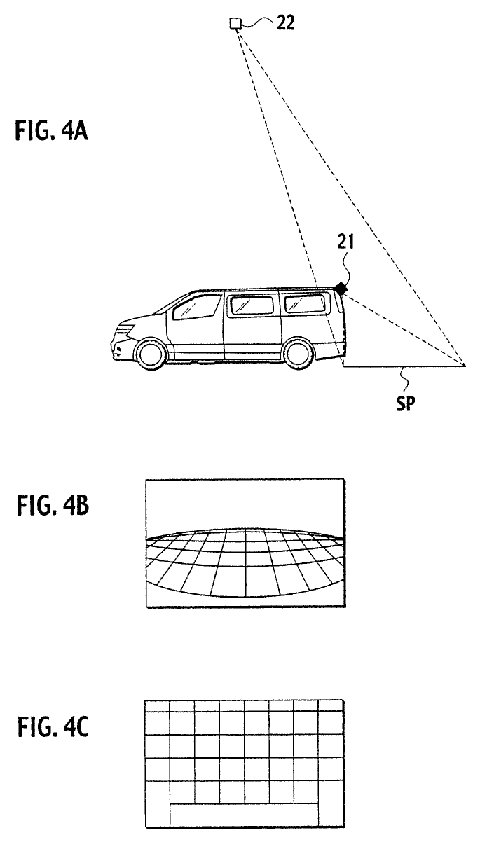

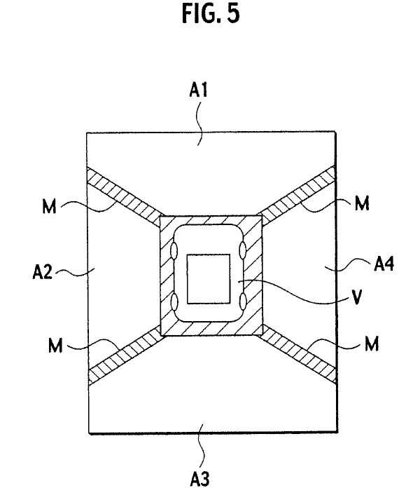

The image synthesis unit 11 viewpoint-changes the front view image, the left side view image, the rear view image, and the right side view image photographed by the on-vehicle cameras 1a to 1d into overview images by using a conversion table 15 describing a correspondence of image addresses between images before and after conversion, and joins these images to form a top view image similar to that shown in FIG. 3. The viewpoint changing process of the image synthesis unit 11 means a process of converting an image similar to that shown in FIG. 4B which is obtained by, for example, photographing a predetermined photographing area SP with an installing position of a real camera 21 of FIG. 4A set as a viewpoint into an overview image (image looking down at a photographing area directly above the vehicle center) similar to that shown in FIG. 4C when a predetermined photographing area SP is photographed by using a virtual camera 22 of FIG. 4A as a viewpoint. A relation between the images before and after conversion is uniquely decided based on lens characteristics of the on-vehicle camera and a mounting angle. Thus, the viewpoint changing process of the image synthesis unit 11 can be realized only by coordinate conversion of an image memory using the conversion table 15. The image synthesis unit 11 carries out the viewpoint changing process for the front view image, the left side view image, the rear view image, and the right side view image photographed by the on-vehicle cameras 1a to 1d, cuts out necessary parts of obtained overview images and joins the images to form a top view image similar to that shown in FIG. 3.

In an image example of FIG. 3, an image area A1 is a cutout of a part of the overview image obtained by subjecting the front view image photographed by the on-vehicle camera 1a to viewpoint changing, an image area A2 is a cutout of a part of the overview image obtained by subjecting the left side view image photographed by the on-vehicle camera 1b to viewpoint changing, an image area A3 is a cutout of a part of the overview image obtained by subjecting the rear view image photographed by subjecting the rear view image photographed by the on-vehicle camera 1c to viewpoint changing, and an image area A4 is a cutout of a part of the overview image obtained by subjecting the right side view image photographed by the on-vehicle camera 1d to viewpoint changing. In the image example of FIG. 3, a shaded area of the image center indicates a position of the vehicle.

Each boundary region created by the image processing device 2 can include a boundary indicator that is superposed on the top view image, such as at the joints of images from the on-vehicle cameras, as will be discussed below. Such a boundary region can be shown in the top view image with a boundary indicator superposed on the top view image at joints between the images from the on-vehicle cameras. The boundary indicator can be, for example, a mask superposed on the top view image.

In another example, a boundary region can include both a boundary indicator superposed on the top view image at joints of images areas, such as image areas A1 to A4 in FIG. 5, as well as portions of the image areas that surround or adjoin the boundary indicator.

The portions of image areas included in a boundary region can be unchanged in appearance due to their inclusion in the boundary region, unless the boundary control unit 13 changes the display form of the image area portions when the appearance of the boundary region is changed, as will be discussed below, or these portions of the image areas included in the boundary region can be changed in appearance due to their inclusion in the boundary region, in relation to portions of the image areas not included in the boundary region. For example, portions of image areas included in a boundary region can have an appearance of relatively lower clarity, resolution, sharpness, brightness, or other distinguishing visual features in relation to portions of the image areas not included in the boundary region.

The boundary indicator superposition unit 12 superposes boundary indicators M on the top view image at joints of the adjacent image areas A1 to A4 of the top view image formed by the image synthesis unit 11 under control of the boundary control unit 13. For example, the boundary superposition unit 12 can superpose boundary indicators at edges of joints of the image areas A1 to A4 such that no portion of the image areas A1 to A4 is covered, obscured, or changed in appearance. In another example, the boundary superposition unit 12 can superpose boundary indicators such that portions of image areas A1 to A4 adjacent to joints of the image areas A1 to A4 are covered or obscured from view. In another example, the boundary superposition unit 12 can superpose boundary indicators such that portions of image areas A1 to A4 adjacent to joints of the image areas A1 to A4 are changed in appearance. In particular, portions of the image areas A1 to A4 covered by boundary indicators can have an appearance of relatively lower clarity, resolution, sharpness, brightness, or other distinguishing visual features in relation to portions of the image areas not covered the boundary indicators.

The top view image formed by the image synthesis unit 11 is an image formed by joining the overview images by the viewpoint changing process as described above. Thus, image distortion caused by an influence of the viewpoint changing concentrates on the joints of the image areas A1 to A4 which are joints of the overview images, causing a loss of image continuity. Especially, when a solid object of a road appears in the joints of the image areas A1 to A4 of the top view image, recognition of the solid object is difficult because of image discontinuity. Accordingly, for example, as shown in FIG. 5, the boundary superposition unit 12 superposes boundary indicators M on the joints of the adjacent image areas A1 to A4 of the top view image formed by the image synthesis unit 11, thereby enabling an occupant of the vehicle to recognize presence of joints which causes a lack of accuracy of the image. In another example, the boundary indicators M can be masks superposed on the joints of the adjacent image areas A1 to A4 of the top view image. In the image example of FIG. 5, the vehicle V of the image center is a computer graphics (CG) image superposed on the top view image to enable the vehicle occupant to understand a position of the vehicle.

As described above, the boundary indicators M are superposed on the top view image to cover the joints, and inaccuracy of the image of these parts is presented to the occupant of the vehicle to give a warning. However, if the boundary indicators M are always superposed in a fixed display form, for example, when the occupant of the vehicle gets used to this display, there is a possibility that the boundary indicators M will lose visibility to cause a reduction in effectiveness of the warning.

Thus, the vehicle image display system of the present invention includes the boundary control unit 13 disposed in the image processing device 2. This boundary control unit 13 enables proper changing of the display form of at least a partial area of at least one boundary region of the top view image. For example, the boundary control unit 13 can change the display form of at least a portion of boundary indicators M superposed on the top view image. In another example, the boundary control unit 13 can change the display form of an entirety of at least one boundary region that includes both a boundary indicator M superposed on the top view image and portions of the image areas A1 to A4 of the top view image that surround or adjoin the boundary indicator M. For instance, the boundary control unit 13 can change the display form of a partial area or entirety of at least one boundary region that includes the boundary indicator M in FIG. 5 located between image areas A1 and A2, as well as portions of image areas A1 and A2 that surround or adjoin the boundary indicator M located between image areas A1 and A2. Additionally, the boundary control unit 13 can change the appearance of at least a partial area or entirety of one boundary region, more than one boundary region, or all boundary regions in the top view image.

In particular, the boundary region control unit 13 can control the display form of at least a partial area of at least one boundary region, so that the partial area or entirety of the boundary region of the top view image can be changed in appearance only until a passage of predetermined time after predetermined conditions are established.

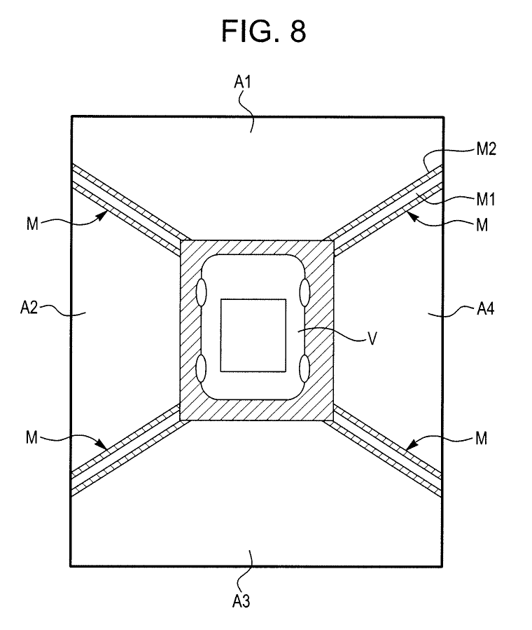

The boundary control unit 13 can also control the display form of one or more boundary regions such that a partial area, or an entirety, of one or more boundary regions is changed in appearance or highlighted. As shown in the example of FIG. 8, the appearance of a partial area M1 of a boundary indicator M can be changed while leaving the appearance of a remainder M2 of the boundary indicator unchanged. As shown in the example of FIG. 8, the partial area M1 of the boundary indicator can be located in a central area of the boundary indicator along a direction extending between a center of the top view image towards a corner of the top view image.

In another example, the partial area of a boundary region that is changed in appearance by the boundary control unit 13 can be located in a portion of an image area A1 to A4 that is included in the boundary region or can be an entirety of that image area portion. For example the boundary control unit 13 can change the appearance of a boundary region that includes a boundary indicator M between image areas A1 and A2 in FIG. 5 and portions of image areas A1 and A2 by changing the appearance of at least one of the portions of the image areas A1, A2 included in the boundary region. In a further example, the appearance of the image area portion can be changed by creating a visual shape, such as a circle, line, or other shape, within the image area portion included in the boundary region or by changing the color, brightness, or other visual character of the image area portion.

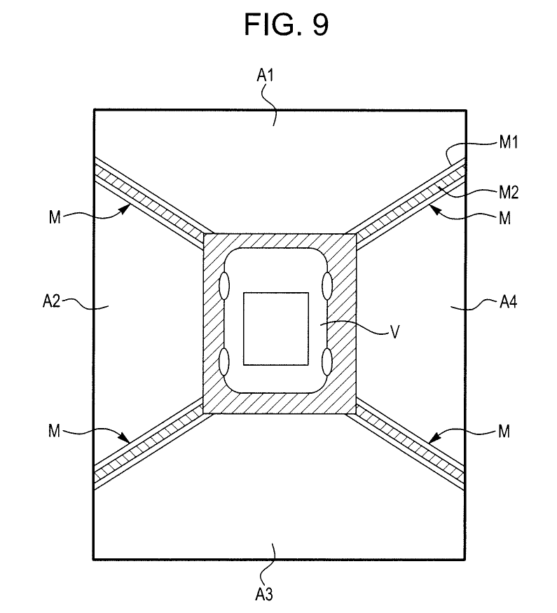

In another example, the partial area M1 of the boundary indicator M that is changed in appearance can be located in a region of the boundary indicator M other than a central area of the boundary indicator. FIG. 9 depicts another example that basically reverses the areas of the boundary indicators M that are changed in appearance in the example of FIG. 8, with the partial area M1 changed in appearance and a remainder M2 located in a central portion of the partial area M1 left unchanged.

Although the examples of FIGS. 8 and 9 show partial areas M1 that extend along the entire length of the boundary indicators M, the partial areas M1 can extend along less than the entire length of the boundary indicators M, or the partial areas M1 can extend intermittently along the entire length or less than the entire length of the boundary regions M. The partial areas M1 can be located in the middle of the boundary indicators M, to one or more lateral sides of the boundary indicators M, or at one or more distal ends of the boundary indicators M. Furthermore, the partial areas M1 can have different sizes and shapes, as would occur to those skilled in the art, in light of these teachings.

The predetermined conditions are conditions for specifying situations which need warning by the boundary regions to the occupant of the vehicle, for example, a case in which after the ignition switch 4 is turned ON, the top view image is first displayed in the display 3 according to an operation of the camera switch 5. As conditions, in addition to the case in which the top view image is first displayed after the ignition switch is turned ON, various conditions can be set according to experience or market demands. The predetermined time is set to sufficiently direct attention of the occupant of the vehicle to the boundary regions of the top view image, for example, 7 seconds.

An example of changing an appearance of at least partial areas or the entirety of one or more boundary regions is changing of a display color of the partial area or entirety of the at least one boundary region, such as to highlight at least the partial area of the boundary region. In other words, the boundary regions are displayed by a conspicuous color, such as yellow, to give a warning only until a passage of predetermined time after predetermined conditions are established, and then displayed by a relatively inconspicuous color, such as black. Even in the case of the same color, it is effective to change the appearance of the boundary regions or to highlight the boundary regions by displaying at least partial areas of the boundary regions by a first luminance only until the passage of predetermined time after the predetermined conditions are established, and then to display the boundary regions by a second luminance lower than the first luminance. Even in the case of the same color, it is effective to highlight the boundary regions by flashing or blinking the boundary regions only until the passage of predetermined time after the predetermined conditions are established, and then to continue displaying of the boundary regions. Further, if the boundary regions are flashed or blinked by a conspicuous color, such as yellow, to be displayed until the passage of predetermined time after the predetermined conditions are established, and then the boundary regions are continuously displayed by a relatively inconspicuous color, such as black, effectiveness of warning can be enhanced more.

The control of the highlighting of the boundary regions by the boundary control unit 13 may be executed by using setting in which control of the highlighting is valid as a condition according to a switch operation of the occupant of the vehicle. Accordingly, the occupant of the vehicle can select whether to execute highlighting control of the boundary regions, solving a problem that the occupant of the vehicle feels irritated because of execution of unnecessary control.

In the highlighting control of the boundary regions, the boundary regions can be changed from a highlighted state to a normal display state after the passage of predetermined time after the predetermined conditions are established. This display change of the boundary regions is preferably executed slowly, taking predetermined time, for example, 2 seconds. Thus, uncomfortable feelings caused by an extreme change of the display form of the boundary regions can be reduced.

For example, when one or more boundary regions, or partial areas thereof, are displayed with a conspicuous color to provide a warning and then displayed with a relatively inconspicuous color, the normal display of the boundary regions will be with the inconspicuous color, such as black. When the boundary regions, or partial areas thereof, are displayed with a first luminance and then displayed with a second luminance lower than the first luminance, the normal display of the boundary regions will be with the second luminance. When the boundary regions, or partial areas thereof, are flashed or blinked and then displayed continuously with the same color, the normal display of the boundary regions will be with the continuous, same color. When the boundary regions, or partial areas thereof, are flashed or blinked with a conspicuous color and then displayed continuously with a relatively inconspicuous color, the normal display of the boundary regions will be with the continuous, relatively inconspicuous color.

As described above, the boundary control unit 13 basically controls the highlighting of the boundary regions to prevent a reduction in effectiveness of warning to the occupant of the vehicle. Additionally, a display form in which a display color or a luminance of the boundary regions is changed according to an environmental change such as brightness in the car room can be controlled. Specifically, for example, control may be executed in such a manner that the boundary regions are displayed black in the daytime, and displayed white or flashed black and white at night by using an ON/OFF signal of the vehicle lighting or a signal from an automatic light sensor. Accordingly, by executing control to optimally change the display form of the boundary regions according to an environmental change, it is possible to effectively curtail a reduction in visibility of the boundary regions of the top view image.

According to various signals input from a car speed sensor 6, a reverse position switch 7, an image changing switch 8, and a side blind switch 9, the image selection unit 14 selects an image to be displayed as an image to be monitored in the display 3 among the front view image photographed by the on-vehicle camera 1a, the left side view image photographed by the on-vehicle camera 1b, the rear view image photographed by the on-vehicle camera 1c, the right side view image photographed by the on-vehicle camera 1d, and the top view image formed by the image synthesis unit 11 and having the boundary indicators M superposed thereon by the boundary indicator superposition unit 12.

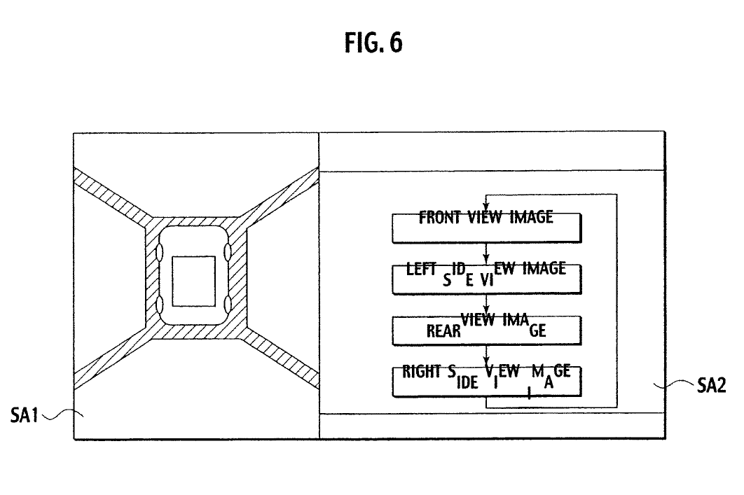

FIG. 6 shows a screen configuration example of an image displayed in the display 3 to be monitored. In the example of FIG. 6, for the image displayed in the display 3 to be monitored, an entire screen is divided into two left and right sides. A top view image can be displayed in a display area SA1 of the screen left side, and any one of a front view image, a left side view image, a rear view image, and a right side view image can be displayed in a display area SA2 of the screen right side.

In the case of the screen configuration example of the image to be monitored shown in FIG. 6, upon recognition that the image to be monitored is displayed in the display 3 by an operation of the camera switch 5, the image selection unit 14 first selects a top view image having boundary indicators M superposed thereon as an image to be displayed in the display area SA1 of the screen left side, and a front view image as an image to be displayed in the display area SA2 of the screen right side. Then, when the occupant of the vehicle operates the screen changing switch 8, the image selection unit 14 switches images to be displayed in the display area SA2 of the screen right side in an order of a front view image→right side view image→rear view image→left side view image→the front view image . . . . Upon reception of a reverse signal indicating setting of a shift position to reverse from the reverse position switch 7, the image selection unit 14 switches the image to be displayed in the display area SA2 of the screen right side to the rear view image irrespective of the aforementioned switching order.

When the occupant of the vehicle operates the side blind switch 9, the image selection unit 14 switches the image to be displayed in the display area SA1 of the screen left side from the top view image to the right side view image. Then, when the side blind switch 9 is operated again, the image to be displayed in the display area SA1 of the screen left side is switched from the right side view image to the top view image. The displaying of the image to be monitored is carried out under the condition that a traveling speed of the vehicle is less than a predetermined value. When the traveling speed of the vehicle is determined to be equal to or more than the predetermined value based on a signal from the car speed sensor 6, the image to be displayed in the display 3 is switched from the image to be monitored to an original image, i.e., a navigation image or a television image displayed in the display 3 before the camera switch 5 is operated to start displaying of the image to be monitored.

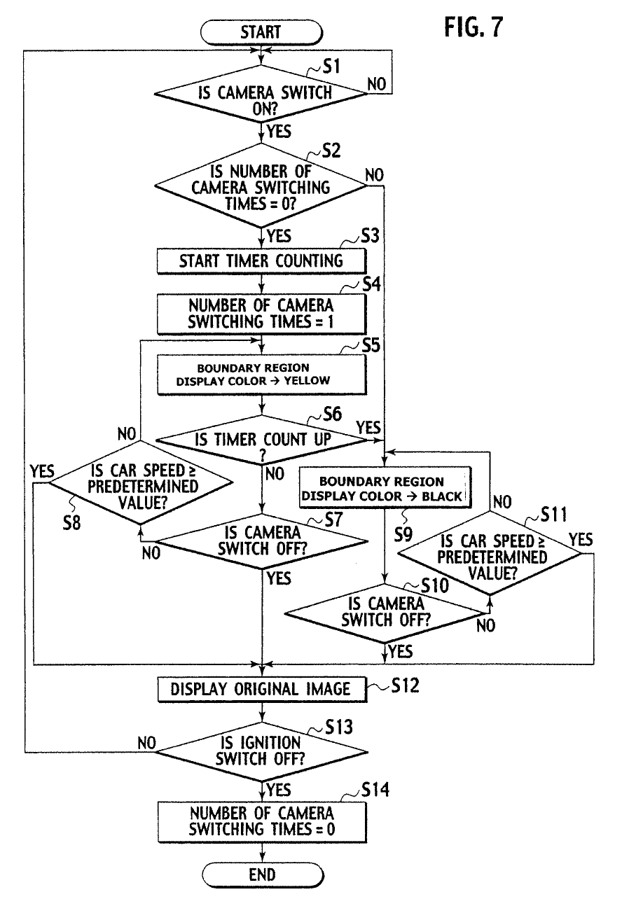

Next, referring to a flowchart of FIG. 7, an operation of the vehicle image display system of the embodiment configured in the aforementioned manner will be described focusing on the display control of the boundary regions which is a feature of the present invention. The flowchart of FIG. 7 shows a specific example of a process of the display control of the boundary regions executed by the image processing device 2 after the vehicle ignition switch 4 is turned ON in the vehicle image display system of the embodiment. According to this example, it is presumed that a top view image is displayed for the first time after the ignition switch 4 is turned ON, boundary regions, or at least partial areas thereof, of a top view image are changed in appearance. One or more boundary regions, or at least partial areas thereof, can be changed in appearance by using any of the methods described herein, such as, for example, highlighting one or more boundary regions, or at least partial areas thereof, in yellow. In the image processing device 2, a process of fetching a front view image, a left side view image, a rear view image, and a right side view image photographed by the on-vehicle cameras 1a to 1d to save the images, and forming a top view image from these images is executed in parallel with the process shown in FIG. 7.

Upon turning-ON of the vehicle ignition switch 4, the image processing device 2 first monitors an ON-operation of the camera switch 5 in step S1. When the occupant of the vehicle turns the camera switch 50N to input an ON-signal therefrom, the image processing device 2 checks whether the number of camera switching times is 0 in step S2. The number of camera switching times indicates the number of turning ON the camera switch 5 while the ignition switch 4 is ON. An initial value is 0, and incremented each time the camera switch 5 is turned ON. Accordingly, when the camera switch 5 is turned ON for the first time after the ignition switch 4 is turned ON, the number of camera switching times is 0.

The image processing device 2 displays an image to be displayed which contains the top view image in the display 3 according to the ON-operation of the camera switch 5. In this case, if a result of the determination in the step S2 shows the number of camera switching times=0, in next step S3, timer counting for counting predetermined time (e.g., 7 seconds) is started. In step S4, the number of camera switching times is incremented to 1. Then, in step S5, the appearance of one or more boundary regions, or at least partial areas thereof, is changed, such as by selecting yellow as a display color for one or more boundary regions, or partial areas thereof, of the top view image, with the top view image having the boundary regions thus changed in appearance.

The change in appearance or highlight-displaying of one or more boundary regions, or at least partial areas thereof, in the top view image, such as by using yellow as the display color of the boundary regions, is continued until the timer counting started in the step S3 is counted up as long as the camera switch 5 is ON and the vehicle traveling speed is less than the predetermined value. Upon determination of counting-up of the timer counting in step S6, the process proceeds to step 9 to switch the appearance, such as the display color, of the one or more boundary regions, or partial areas thereof, of the top view image, such as by changing the display color from yellow to black.

If an OFF-operation of the camera switch 5 is detected before the timer counting started in the step S3 is counted up in step S7, the process proceeds to step S12 to switch the image displayed in the display 3 from the image to be monitored to an original image such as a navigation image or a television image. If the vehicle traveling speed is determined to be equal to or more than the predetermined value based on a signal from the car speed sensor 6 before the timer counting started in the step S3 is counted up in step S8, the process proceeds to the step S12 to switch the image displayed in the display 3 from the image to be monitored to the original image.

When ON and OFF operations of the camera switch 5 is repeated by a plurality of times while the ignition switch 4 is ON, the image processing device 2 displays the image to be monitored which contains the top view image in the display 3 each time the camera switch 5 is turned ON. In this case, as the number of camera switching times is a value other than 0, the determination result of the step S2 is NO. In this case, in step S9, the image processing device 2 selects black as a display color of the one or more boundary regions, or partial areas thereof, of the top view image, and displays the top view image having the black boundary regions superposed thereon to cover the joints of the images as an image to be monitored in the display 3. The displaying of the image to be monitored is continued as long as the camera switch 5 is ON and the vehicle traveling speed is less than the predetermined value. If an OFF-operation of the camera switch 5 is detected in step S10, or if the vehicle traveling speed is determined to be equal to or more than the predetermined value based on a signal from the car speed sensor 6 in step S11, the process proceeds to the step S12 to switch the image displayed in the display 3 from the image to be monitored to the original image.

Subsequently, in step S13, the image processing device 2 monitors switching of the vehicle ignition switch 4 from ON to OFF. The process of the step S1 and after is repeated if the ignition switch 4 is ON. Upon switching of the ignition switch 4 to OFF, in step S14, the number of camera switching times is reset to 0, and the series of operations is finished.

As described above by taking the specific examples, according to the vehicle image display system of the embodiment, when the image processing device 2 subjects the images photographed by the on-vehicle cameras 1a to 1d to viewpoint changing, and joins the images to form a top view image, and superposes the boundary indicators M on the joints of the top view image to display the image with boundary regions in the display 3 to be monitored by an occupant of a vehicle, for example, one or more boundary regions, or at least partial areas thereof, of the top view image are changed in appearance, such as by highlighting at least partial areas of one or more boundary regions, until the passage of predetermined time after the predetermined conditions such as first top view image displaying time after the ignition switch is turned ON are established. Thus, the boundary regions can be made conspicuous, especially in a situation in which a warning should be given to the occupant of the vehicle by the boundary regions, and the easily seen top view image can be displayed as an image to monitored in the display 3 while preventing a reduction in effectiveness of the warning by the boundary regions.

The entire contents of a Japanese Patent Application No. P2006-186719 with a filing date of Jul. 6, 2006 and a Japanese Patent Application No. P2007-158647 with a filing date of Jun. 15, 2007 in Japan are herein incorporated by reference.

Although the invention has been described above by reference to certain embodiments of the invention, the invention is not limited to the embodiments described above. Modifications and variations of the embodiments described above will occur to those skilled in the art, in light of the teachings. The scope of the invention is defined with reference to the following claims.

What is claimed is:

1. A vehicle image display system, comprising:
a plurality of on-vehicle cameras configured to photograph surroundings of a vehicle;
an image synthesis unit configured to join a plurality of images photographed by the plurality of on-vehicle cameras to form a composite image having boundary regions;
a boundary indicator superposition unit configured to superpose boundary indicators on the composite image at joints of the plurality of images;
a display unit configured to display the composite image having the boundary indicators superposed thereon; and
a boundary control unit configured to change an appearance of at least a partial area of at least one boundary region of the composite image.

2. The vehicle image display system according to claim 1, wherein the boundary control unit changes the appearance of at least the partial area of the at least one boundary region of the composite image until a passage of a predetermined amount of time after the composite image is first displayed when an ignition switch of the vehicle is turned ON.

3. The vehicle image display system according to claim 1, wherein the boundary indicators are masks.

4. The vehicle image display system according to claim 1, wherein the boundary control unit is configured to change the appearance of at least the partial area of the at least one boundary region after at least one predetermined condition has been established.

5. The vehicle image display system according to claim 4, wherein the boundary control unit is configured to change the appearance of at least the partial area of the at least one boundary region after the at least one predetermined condition has been established and until a passage of a predetermined amount of time has occurred.

6. The vehicle image display system according to claim 5, wherein the boundary control unit changes the appearance of at least the partial area of the at least one boundary region by flashing the at least partial area of the at least one boundary region of the composite image until the passage of the predetermined amount of time after the at least one predetermined condition has been established, and continues to display the at least one boundary region after the passage of the predetermined amount of time.

7. The vehicle image display system according to claim 6, wherein the boundary control unit changes the appearance of the at least one boundary region by flashing at least the partial area of the at least one boundary region of the composite image with a first display color until the passage of the predetermined amount of time after the at least one predetermined condition has been established, and continues the displaying of the boundary regions with a second display color after the passage of the predetermined amount of time.

8. The vehicle image display system according to claim 7, wherein the first display color is yellow, and the second display color is black.

9. The vehicle image display system according to claim 5, wherein the boundary control unit changes the appearance of the at least partial area of the at least one boundary region by displaying the at least partial area of the at least one boundary region of the composite image by a first display color until the passage of the predetermined amount of time after the at least one predetermined condition has been established, and displays the at least one boundary region by a second display color after the passage of the predetermined amount of time.

10. The vehicle image display system according to claim 9, wherein the first display color is yellow, and the second display color is black.

11. The vehicle image display system according to claim 5, wherein the boundary control unit changes the appearance of the at least partial areas of the at least one boundary region by displaying the at least partial area of the at least one boundary region of the composite image by a first luminance until the passage of the predetermined amount of time after the at least one predetermined condition has been established, and displays the at least one boundary region by a second luminance after the passage of the predetermined amount of time.

12. The vehicle image display system according to claim 1, wherein the boundary control unit is configured to change the appearance of the at least partial area of the at least one boundary region by highlighting the at least partial area of the at least one boundary region.

13. The vehicle image display system according to claim 1, wherein the appearance of only the partial area is changed.

14. The vehicle image display system according to claim 1, wherein an entirety of the at least one boundary region is changed in appearance.

15. The vehicle image display system according to claim 1, wherein the appearance of the at least partial area of the at least one boundary region is changed, the appearance of a portion or an entirety of a boundary indicator is changed when the appearance.

16. The vehicle image display system according to claim 1, wherein the at least partial area is a partial area of a boundary indicator located in a central area of a boundary indicator along a direction from a center of a top view image toward a corner of the top view image.

17. The vehicle image display system according to claim 1, wherein the at least partial area is a partial area located in a region of a boundary indicator other than a central area of the boundary indicator.

18. A vehicle image display system comprising:
a plurality of on-vehicle cameras configured to photograph surroundings of a vehicle;
an image synthesis unit configured to join a plurality of images photographed by the plurality of on-vehicle cameras to form a composite image having boundary regions;
a boundary superposition unit configured to superpose boundary indicators on the composite image at joints of the plurality of images;
a display unit configured to display the composite image having the boundary indicators superposed thereon; and
a boundary control unit configured to cause the display unit to continuously display at least a partial area of at least one boundary region of the composite image in yellow until a passage of a predetermined amount of time after the composite image is first displayed when an ignition switch of the vehicle is turned ON, and continuously display the at least one boundary region in black after the passage of the predetermined amount of time.

19. A vehicle image display system comprising:
photographic means for photographing surroundings of a vehicle;
means for joining a plurality of images photographed by the photographic means to form a composite image having boundary regions;
means for superposing boundary indicators on the composite image at joints of the plurality of images;
means for displaying the composite image having the boundary indicators superposed thereon; and
means for changing an appearance of at least a partial area of at least one boundary region of the composite image.

20. An image display method for joining a plurality of images of surroundings of a vehicle photographed by a plurality of on-vehicle cameras to form a composite image having boundary regions, superposing boundary indicators on the composite image at joints of the plurality of images, and displaying the composite image on a display unit, comprising the steps of:
carrying out boundary display control by changing the appearance of at least a partial area of at least one boundary region of the composite image.

21. A computer readable medium having program code recorded therein, that, when executed on a computer, causes the computer to perform steps comprising:
joining a plurality of images of surroundings of a vehicle photographed by a plurality of on-vehicle cameras to form a composite image,
superposing boundary indicators on the composite image at joints of the plurality of images,
displaying the composite image on a display unit, and
carrying out boundary display control by changing the appearance of at least a partial area of at least one boundary region on the display unit.
